(19) United States
(12) Patent Application Publication
(10) Pub. No.: US 2018/0033253 A1
(43) Pub. Date: Feb. 1, 2018

(54) GAMING MACHINE WITH EXPANDING SYMBOL COMBINATIONS

(71) Applicant: BALLY GAMING, INC., Las Vegas, NV (US)

(72) Inventors: James W. VANN, Chicago, IL (US); Anthony J. BAERLOCHER, Henderson, NV (US); CHRISTOPHER K. GUERRERO, Las Vegas, NV (US); Jeremy M. HORNIK, Chicago, IL (US); JEFFRY L. NAUMAN, Yorkville, IL (US); KENNETH SHAWN SOONG, Henderson, NV (US)

(21) Appl. No.: 15/224,754

(22) Filed: Aug. 1, 2016

(51) Int. Cl. G07F 17/34; G07F 17/32

(52) U.S. Cl. CPC G07F 17/34; G07F 17/3246; G07F 17/3213; G07F 17/3258; G07F 17/3209

(57) ABSTRACT

A gaming system for performing at least one wagering game includes a regulated electronic wagering game machine comprising one or more input devices and one or more display devices. An initial set of active array elements is determined on a playfield for the wagering game and a symbol is randomly determined for each of the active array elements. As symbols create or expand predetermined symbol combinations in the playfield, the symbols of the predetermined symbol combination are fixed and an expansion set of additional array elements are activated adjacent to new symbols that expand the symbol combination. A random symbol is determined for each expansion set array element. A repeated process of symbol combination expansion and array element activation occurs until the symbol combination expansion stops and a playfield outcome is determined. An evaluation is performed to determine a corresponding award for the playfield outcome.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to specialized wagering gaming machines for receiving a physical item associated with a monetary value, performing one or more wagering games, and initiating a payout from a corresponding credit balance.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

### SUMMARY OF THE INVENTION

According to one aspect of the present invention, a regulated gaming system comprises an electronic display device, one or more electronic input devices, and game-logic circuitry. The regulated gaming system may be incorporated into a single, freestanding gaming machine. The game-logic circuitry is configured to detect a physical item associated with a monetary value that establishes a credit balance via at least one of the one or more electronic input devices. In response to an input indicative of a wager covered by the credit balance, a casino wagering game is initiated and the electronic display device is directed to display a playfield for providing symbol-bearing array elements and display randomly selected initial symbols in respective initial array elements of the playfield. In response to a predetermined combination of the initial symbols, the electronic display device is directed to iteratively display additional symbol-bearing array elements separate from the initial array elements and present randomly selected additional symbols in the respective additional symbol-bearing array elements of the playfield until the additional symbols no longer extend the predetermined combination. At least one instance of the iterative displaying of additional symbol-bearing array elements occurs after at least one of the randomly selected additional symbols has been presented. After the additional symbols no longer extend the predetermined combination, the credit balance is incremented with an award amount corresponding to an evaluation of the final playfield outcome and a cashout input is received via at least one of the one or more electronic input devices that initiates a payout from the credit balance.

According to one aspect of the present invention a gaming system is described comprising a regulated gaming machine and game-logic circuitry. The regulated gaming machine includes an electronic display device and one or more electronic input devices, and is primarily dedicated to playing at least one casino wagering game. The game-logic circuitry is configured detect a physical item associated with a monetary value that establishes a credit balance via at least one of the one or more electronic input devices, and initiate a casino wagering game in response to an input indicative of a wager covered by the credit balance. In response to initiating the casino wagering game, the electronic display device is directed to display at least a portion of a playfield for providing symbol-bearing array elements and display randomly selected initial symbols in respective initial array elements of the playfield. In response to a predetermined combination of the initial symbols, the electronic display device is directed to iteratively display randomly selected additional symbols in additional symbol-bearing array elements adjacent to the predetermined combination and present the randomly selected additional symbols in the respective additional symbol-bearing array elements of the playfield until the additional symbols no longer extend the predetermined combination. At least one instance of the iterative displaying of additional symbol-bearing array elements occurs after at least one of the randomly selected additional symbols has been presented and at least one of the additional symbol-bearing array elements is separate from the initial array elements. The credit balance is incremented with an award amount corresponding to an evaluation of the final playfield outcome and a cashout input is received via at least one of the one or more electronic input devices that initiates a payout from the credit balance.

A gaming system is described comprising a regulated gaming machine primarily dedicated to playing at least one casino wagering game and game-logic circuitry. The gaming machine includes one or more electronic display devices and one or more electronic input devices. The game-logic circuitry is configured to detect a physical item associated with a monetary value via at least one of the one or more electronic input devices that establishes a credit balance and initiates a casino wagering game in response to an input indicative of a wager covered by the credit balance. The electronic display device is directed to display a playfield for providing symbol-bearing array elements upon initiation of the casino wagering game. The credit balance is incremented with an award amount corresponding to an outcome of the casino wagering game and a cashout input received via at least one of the one or more electronic input devices initiates a payout from the credit balance. Means for directing the electronic display device to iteratively display additional symbol-bearing array elements separate from the initial array elements are disclosed, in addition to presenting randomly selected additional symbols in the respective additional symbol-bearing array elements of the playfield until the additional symbols no longer extend the predetermined combination. At least one instance of the iterative displaying of additional symbol-bearing array elements occurs after at least one of the randomly selected additional symbols has been presented.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIGS. 4A-4B are images of an exemplary game screen of a wagering game displayed on a gaming machine, each according to an embodiment of the present invention.

FIGS. 5A-5F are images of an exemplary game screen of a wagering game displayed on a gaming machine, according to an embodiment of the present invention.

FIG. 6 is an image of an exemplary game screen of a wagering game displayed on a gaming machine, according to an embodiment of the present invention.

FIG. 7A is an image of an exemplary game screen of a wagering game displayed on a gaming machine, according to an embodiment of the present invention.

FIG. 7B is an image of an exemplary game screen of a wagering game displayed on a gaming machine, according to an embodiment of the present invention.

FIG. 7C is an image of an exemplary game outcome screen of a wagering game displayed on a gaming machine, according to an embodiment of the present invention.

FIG. 8A is a flowchart for a data-processing method corresponding to instructions executed by a controller to perform a wagering game in one embodiment of the present invention in accord with at least some aspects of the disclosed concepts.

FIG. 8B is a flowchart for a data-processing method corresponding to instructions executed by a controller to perform a wagering game in one embodiment of the present invention in accord with at least some aspects of the disclosed concepts.

FIG. 9 is a flowchart for a data-processing method corresponding to instructions executed by a controller to perform an evaluation of a playfield outcome in a wagering game in accord with at least some aspects of the disclosed concepts in one embodiment of the present invention.

FIGS. 10A-10C are flowcharts for a data-processing method corresponding to instructions executed by a controller to perform a specific type of evaluation of a playfield outcome in a wagering game in accord with at least some aspects of the disclosed concepts in one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

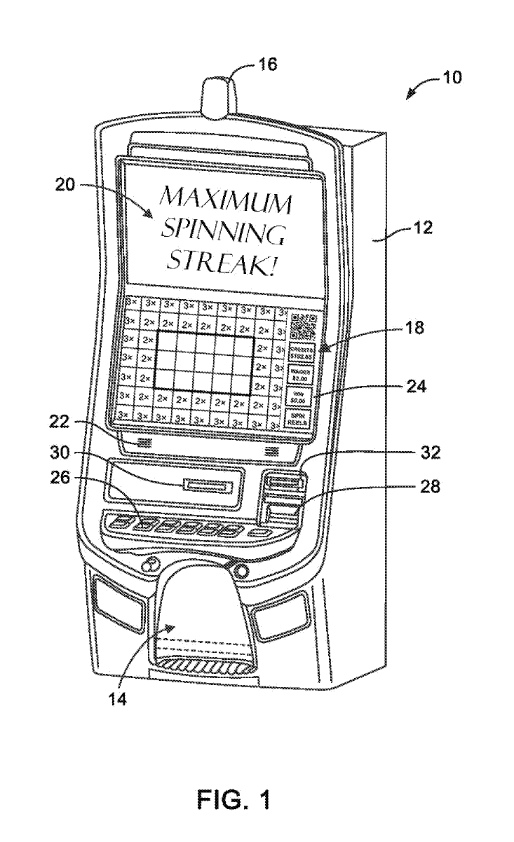

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

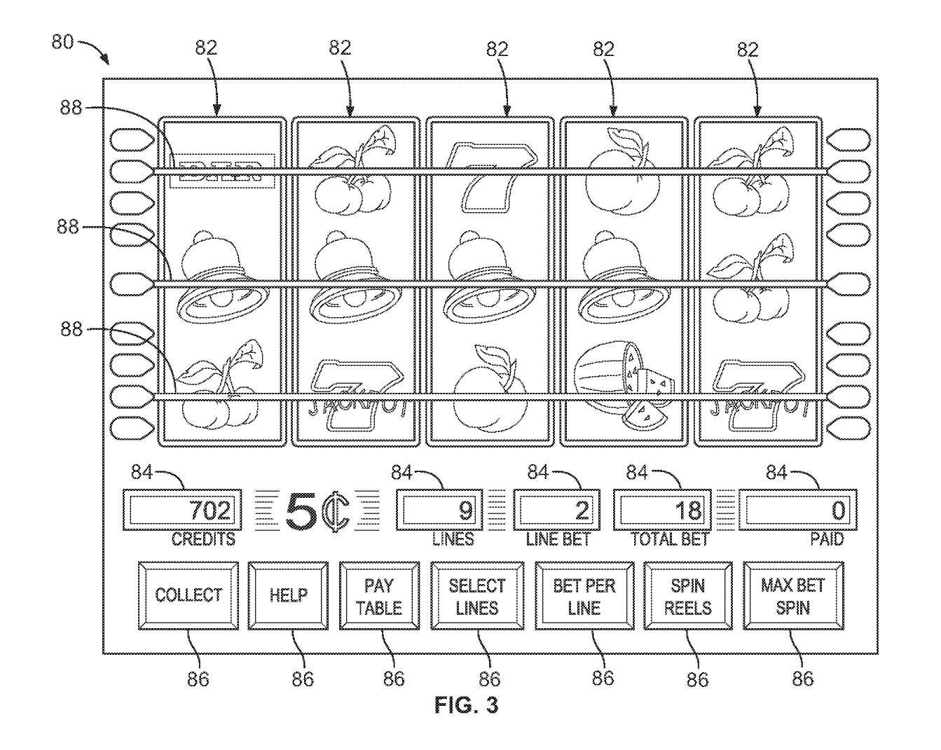

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

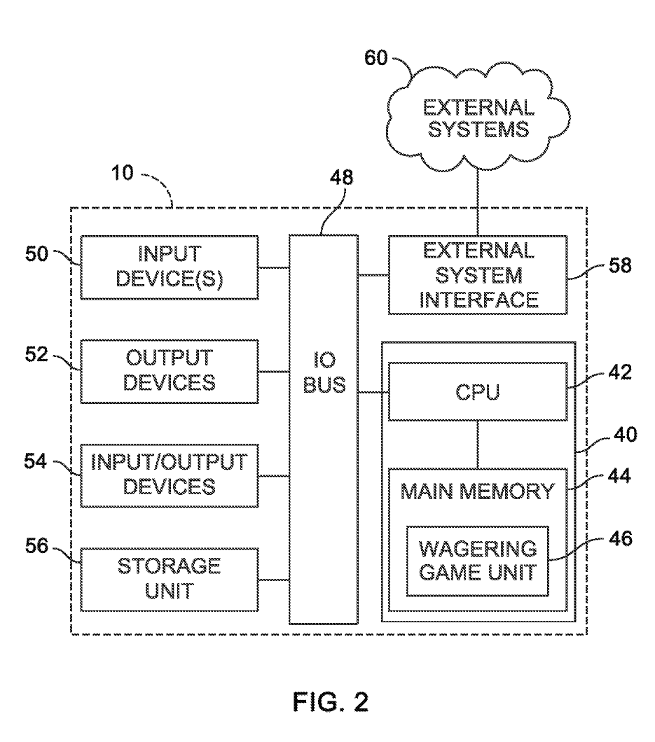

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

In one embodiment, a system and method for performing a casino wagering game includes dedicated and specialized hardware. One or more display devices provides a graphical user interface to a player comprising a playfield defined having a set of adjacent or connected array elements. One or more initial arrays may be defined as a subset of the playfield. Each initial array contains a set of active array elements. During the wagering game, each activated array element displays an independent and randomly determined symbol. Once a symbol is determined and displayed for an activated array element, the array element is deactivated. In response to an array element being determined as part of a predetermined symbol combination in the playfield, the array element becomes fixed and is unable to be re-activated until a special feature or event of the wagering game occurs.

As displayed symbols create or expand predetermined combination of symbols on the playfield (e.g., a minimum of three adjacent or connected matching symbols or the expansion of a previously displayed set of matching symbols), the symbols of the predetermined combination may become collectively static (i.e., remain unchanged) as the wagering game progresses. In one embodiment, as new symbols are displayed establishing or expanding a new predetermined symbol combination, additional array elements of the playfield adjacent to the new symbols become activated. The process of determining new symbol combinations continues until expansion stops and a final symbol combination has been determined. An evaluation is performed based on the final symbol combination displayed in the playfield array.

In some embodiments, one or more features may be randomly triggered that change one or more (e.g., all) symbols of a symbol combination. That is, an expanding symbol combination may be impacted or directly modified by one or more features of the wagering game. For example, a selected subset of symbols of a symbol combination may become WILD symbols in response to a given trigger. In one embodiment, a feature may selectively activate or deactivate particular array elements that are not directly adjacent to new symbol(s) of an expanding symbol combination. Features may be triggered directly using random elements (e.g., randomly generated numbers via a RNG) or be the result of activating specific array elements of the playfield. Further, the expansion of a symbol combination in a particular fashion may trigger one or more features. Events or wagering game features may additionally be triggered by specific predefined shapes or sizes of symbol combinations achieved during expansion, one or more symbols being displayed and/or part of a symbol combination, a specific array element or combination of array elements of the playfield being part of a symbol combination, achieving a watermark or symbol count, etc.

A corresponding award may be determined using one or more methods for evaluation for one or more predetermined symbol combinations in a playfield outcome after all expansion has concluded. Evaluation of an award for a symbol combination may include scatter pays (number of symbols), adjacent-scatter pays (number of adjacent symbols), line pays (specific combination of connected symbols), size pays (dimensions of combination expansion), value pays (each symbol having an associated value), picture pays (configuration of symbols in a combination), reveal pays (position of symbols in the playfield or revealing patterns of symbols on the playfield), combination pays (revealing multiple positions of the playfield), etc. Activating specific array elements of the playfield may also trigger particular events, features, or award amounts impacting the overall evaluation for the symbol combination, such as the granting of amount multipliers, additional prizes, etc.

### Wagering Game Initialization

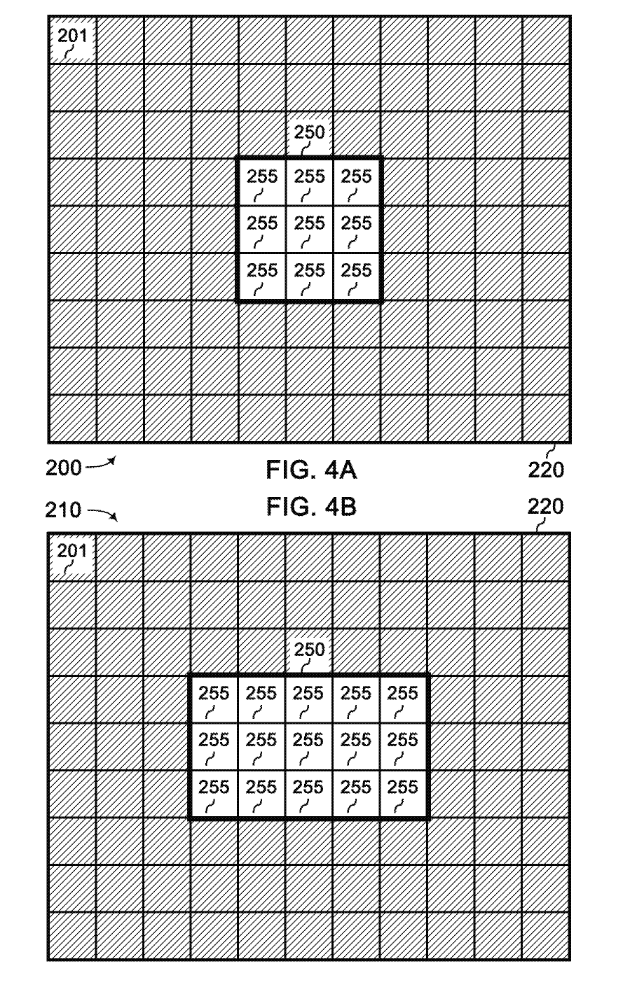

Referring now to FIG. 4A, there is illustrated an image of a game screen 200 adapted to be displayed on one or more displays of an electronic wagering game machine (e.g., gaming machine 10). The game screen 200 includes a playfield 220 comprised of a set of array elements 201 used to conduct a casino wagering game. A section of the playfield 220 is defined as an initial set of array elements 250. The initial set of array elements 250 comprises individual initially activated array elements 255. In some embodiments, the wagering game may be initiated with a playfield 220 having multiple, disjointed initial sets of array elements 250.

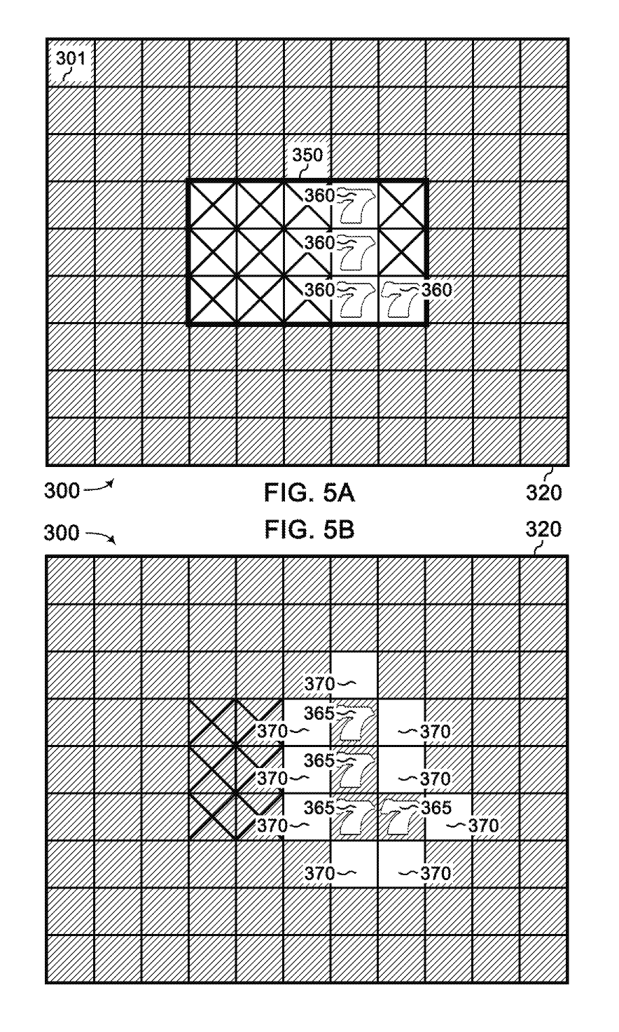

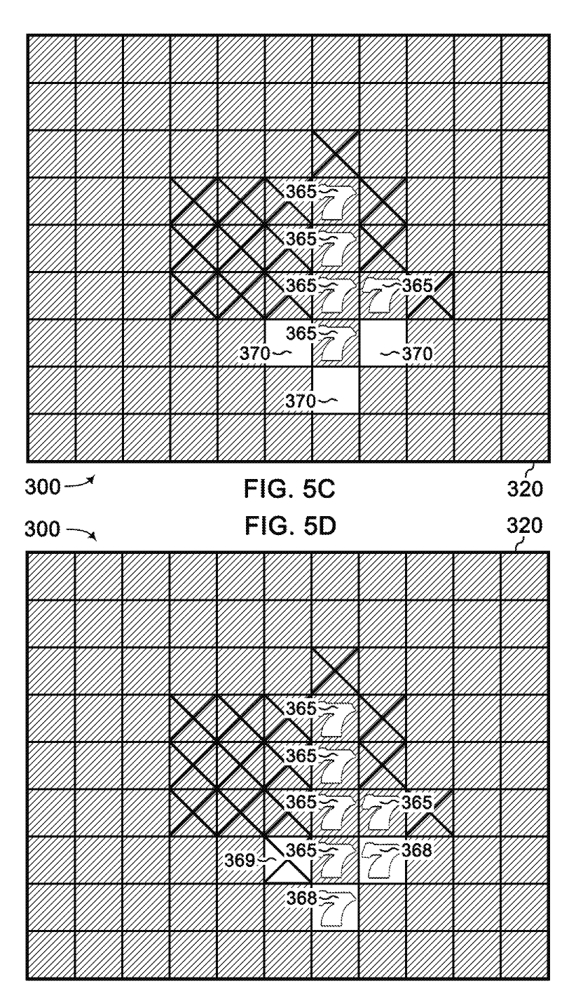

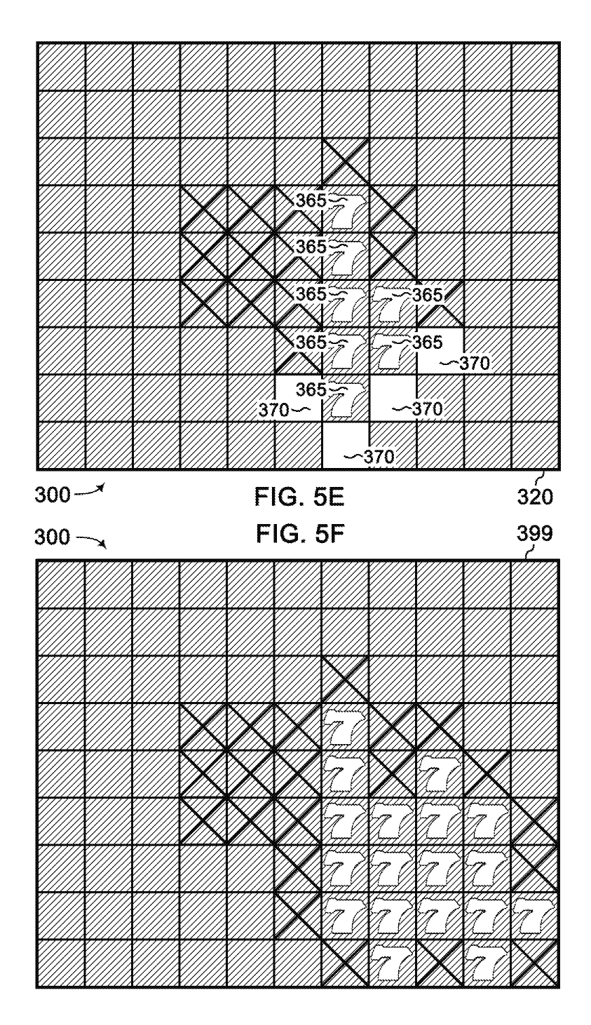

In some embodiments, each array element 201 of the playfield 220 is independent from other array elements of the playfield 220. In other embodiments, a set of array elements 201 may be related, such as displaying a randomly determined symbol from a common reel strip. At the initiation of a wagering game, the array elements 201 of the initial set 250 are activated (indicated by white, no hatching), becoming initially activated array elements 255. An activated array element 201 will have a random symbol determined for display. Array elements 201 of the playfield 220 that are not a part of the initial set of array elements 250 remain deactivated (indicated by hatching) and will not have symbols immediately determined and displayed as a result of game initiation. Deactivated array elements 201 of the playfield 220 may be displayed greyed out, without a corresponding symbol (i.e., blank), as shown in FIG. 4A. A deactivated array element 201 may display a fixed symbol that has been previously determined until the array element is activated or re-activated (see, e.g., combination symbols 365 illustrated in FIG. 5B). An initially activated array element 255 may have a corresponding randomly determined symbol generated using a symbol-bearing reel strip (or set of available symbols) particular to that specific array element. In some embodiments, an array element 201 being activated (or temporarily marked as activated) results in a corresponding symbol being determined and displayed at the array element 201 and the array element 201 is deactivated. The determination of a symbol for an activated array element 201 (e.g., array elements 255) may be the result of a random element (e.g., a random number used to determine a corresponding reel stop position on an associated reel strip, or be used in conjunction with a lookup table) to determine the displayed symbol for the array element 201. Other randomized methodologies may be additionally or alternatively implemented. Once a symbol is determined and displayed at the location of an activated array element 201, the array element 201 is deactivated. As particular symbol combinations (and/or random triggering events) occur, corresponding array elements 201 of playfield 220, may become activated, deactivated, or re-activated. It is also possible for the playfield 220 to change shape, gaining or losing specific array elements 201 as a result of randomly occurring events during the wagering game.

In some embodiments, the entire playfield 220 is displayed to the player as symbols are determined for activated array elements 201. In other embodiments, particular sections of the playfield 220 are only shown when one or more symbols in activated and previously activated array elements 201 cause a symbol combination to expand. In one embodiment, a specific portion of the playfield 220 that includes initially activated array elements 255 and additional array elements 201 of an expanding symbol combination. This may be achieved by providing a dynamic “zooming-in” and “zooming-out” feature for particular sections of the playfield 220 during gameplay. For example, as array elements 201 of the playfield 220 become activated, the displayed portion of the playfield 220 may include greater numbers of array elements 201 of the playfield 220, including some or all of the initially activated array elements 255. In one embodiment, an initial display of the initial set of array elements 250 on the playfield 220 is displayed at game initiation and transitions into a partial-playfield viewport displaying a region of the playfield 200 larger than the initial set of array elements 250. As one or more symbol combinations expand in the playfield 220, the displayed viewport “zooms-out” to include additional array elements 201 included in the symbol combination expansion.

The number of array elements 201 in the playfield 220 is highly variable and an initial set of array elements 250 may be arranged in any configuration. For example, the initial set of array elements 250 may be a specific one selected from a group of fixed sizes (e.g., 1×1, 1×3, 3×3, 3×5, etc.), and may be based on wager amount. The initial set of array elements 250 includes a corresponding number of array elements 201 that are activated at the initiation of the wagering game. The playfield 220 may be a fixed, maximum size (e.g., 5×5, 10×10, 10×15, etc.), or may allow expansion of symbol combinations in an effectively infinite manner. In one embodiment, a symbol combination in the playfield 220 is allowed to expand until each activated array element 201 displays a symbol that fails to expand the (final) symbol combination. Also, the playfield 220 may have any regular or irregular shape (e.g., square, rectangular, oval, pyramid, etc.), a specific configuration of array elements 201 (e.g., displaying marked rooms with connecting hallways or interconnecting doors, having spotlights or portal views, etc.), or emulate a wide variety of topological properties of surfaces (e.g., toroidal, spherical, edges wrapping around, etc.).

The playfield 220 displays array elements 201 that may be activated (non-shaded, for illustration purposes) or deactivated (shaded, for illustration purposes). In one embodiment, as the wagering game is initialized and begins, all the array elements 201 of the initial set 250 (i.e., initially activated array elements 255) are activated and await randomly determined symbols for display. As the wagering game continues, a symbol is determined for an activated array element and the array element 201 is then deactivated. Once the wagering game is initiated and each of the initially activated array elements 255 display a symbol, a determination is made as to whether a predetermined symbol combination is present in the playfield 220. When a symbol combination occurs or expands, additional array elements 201 become activated, potentially enabling further symbol combination expansion. In order to simplify discussion in the accompanying figures, activated array elements are shown non-thatched indicating a required symbol determination and display process prior to the deactivation of the array element. Symbol determination and symbol display will not occur for the deactivates array elements shown by the thatched array elements of the playfield 220. Once a symbol is determined and displayed for an activated array element, the array element becomes deactivated. A previously deactivated array element may be re-activated in the future as a result of other events (e.g., a randomly triggered feature, another adjacent array element expanding the symbol combination, etc.).

Referring now to FIG. 4B, another embodiment is shown having an image of a game screen 210 adapted for one or more displays during a wagering game. The game screen 210 includes a playfield 220 having fifteen initially activated array elements 255 making up an initial set of array elements 250 in a 3×5 array. In one embodiment, the increased size of the initial set of array elements 250 of game screen 210 may be a result of an increased wager amount (discussed later).

A wagering game may also use multiple distinct initial sets of array elements 250 that are simultaneously designated for the same playfield 220 at the initiation of the wagering game. As symbol combinations expand in the playfield 220 and additional array elements 201 are activated to display symbols, special (or additional) winning combinations of symbols may arise as two or more distinct symbol combinations (i.e., originating in distinct initial sets of array elements 250) expand and merge into a single expanding combination. In one embodiment, the merging of multiple initial sets of array elements 250 imparts an award multiplier for a final winning combination of symbols in the playfield 220 based on the number of merged initial sets of array elements 250. In other embodiments, an award is determined based upon the newly formed (single) symbol combination. For example, consider distinct sets of initial array elements 250 expanding from each corner of the playfield 220. When two or more of the expanding symbol combinations meet and form a single set, a base award or special award may be granted (e.g., a fixed credit award, one or more of a multiplier for another or bonus game instance, an increased scatter pay award for each symbol combination, a merged scatter pay count award, etc.).

It is also possible for separate symbol combinations to occur within the same initial set of array elements 250. In some embodiments, two distinct symbol combinations may separately activate additional array elements 201, and potentially expand into, or away from, one another. In one embodiment, each symbol combination may expand distinctly and be evaluated independently (e.g., the two symbol combinations are evaluated separately once all symbol combination expansion ceases). In another embodiment, independent symbol combinations may become adjacent as a result of expansion. Symbol combinations may merge upon becoming adjacent and be evaluated together as a single combination (e.g., even when the symbol combinations comprise different symbols). In another embodiment, one of the symbol combinations is cleared from the playfield 220 to allow the remaining (e.g., higher-value) symbol combination to expand. In another embodiment, a removed symbol combination is restored to the playfield 220 after the initial symbol combination has completed expanding. An award may be granted that combines the two expansions, or provides a single payout in accordance with the most successful expansion.

The positioning of an initial set of array elements 250 in the playfield 220 may be static, may be determined randomly, may be specified (i.e., selected) by the player, may be a result of a specific or random gaming event, etc., and may even migrate in the playfield 220 (e.g., as a result of prior spins or prior game outcomes). Additionally, the position and/or configuration of the initial set of array elements 250 in the playfield 220 may mutate or move in a predictable or unpredictable fashion from game instance to game instance. In one embodiment, the shape of the initial set of array elements 250 may (predictably or otherwise) change from game instance to game instance. The configuration (including size and shape) of one or more initial sets of array elements 250 in a playfield 220, as well as properties of one or more of the array elements therein, may be randomly determined, may be chosen by a player, may be determined by a skill-based player feat, or may be determined by a combination of any of these.

### Symbol Combination Expansion

Referring now to FIGS. 5A-5F, an image of a game screen 300 as displayed on an electronic wagering game machine (e.g., gaming machine 10) is shown. The sequence of FIGS. 5A-5F demonstrate an exemplary symbol combination expansion conducted and presented to the player during a wagering game via one or more displays of the game machine. The various images and game screen 300 of FIGS. 5A-5F may be presented to a player in the sequence as shown, include additional animations, presentations (both audio and video), and/or may include one or more intermediate presentations as the symbol combination expansion takes place. The specific rules for activation and symbol determination for any additional (expanding) array elements may be highly variable and may include a variety of logistical, procedural, or determinative alternatives that does not depart from the described and intended nature of the invention. Each presentation and processing alternative may be selectively adopted in conjunction with the described symbol combination expansion as expressly displayed in FIGS. 5A-5F.

In FIG. 5A, there is illustrated an image of a game screen 300 displayed on one or more displays of an electronic wagering game machine (e.g., gaming machine 10) during a wagering game. The game screen 300 includes a playfield 320 comprising a set of array elements 301. The playfield 320 includes an initial set of array elements 350 that are activated at initiation of the wagering game. In this example, a wagering game is initialized using the game screen 300 modelled after the game screen 210 shown in FIG. 4B. Each of the array elements 301 of the initial set of array elements 350 displays a determined symbol that has been randomly and independently determined based on one or more random elements. In one embodiment, each array element 301 of the initial set of array elements 350 is activated in response to initiating the wagering game, a symbol is randomly determined and displayed for each activated array element 301 of the initial set 350, and the array elements 301 of the initial set 350 are deactivated. The initial set of array elements 350 is shown after symbols have been determined and displayed prior to deactivation. In response to a predetermined combination of symbols being displayed in the playfield 320, additional array elements 301 may be activated to provide additional expansion (extending) of a symbol combination in the playfield 320.

In the present example, the initial set of array elements 350 includes a predetermined symbol combination formed by the symbols determined and displayed for the array elements 360. The array elements 360 include adjacent and identical “7” symbols forming a new (potentially award winning) symbol combination in the wagering game. In this embodiment, two array elements 301 are considered adjacent when having a common or shared side. In other embodiments, diagonally adjacent array elements 301 may be considered adjacent for purposes of specifying a predetermined or winning symbol combination. A predetermined symbol combination that triggers the activation of additional array elements causing expansion may or may not grant a tangible corresponding award, and may or may not comprise many distinct predetermined symbol combinations. In one embodiment, three or more adjacent and identical symbols form a predetermined symbol combination in the playfield 320 that will trigger a chance for extending the symbol combination through expansion of the symbol combination. In other embodiments, more or fewer symbols may be required to trigger symbol combination expansion, and the presence of WILD symbols may also contribute to a triggering symbol combination. In other embodiments, a predetermined symbol combination having an associated pay table award is required to trigger a chance for extending the symbol combination via expansion.

The remaining array elements 301 of the initial set 350 display symbols that do not contribute to the predetermined combination formed by the symbols in array elements 360 are removed for clarity and ease of explanation. During the determination of symbols for activated array elements 301, symbols may be randomly determined from a set of symbols specific to a corresponding array element 301 using one or more random elements to determine a randomized stop position of a corresponding reel strip. In some embodiments, the number of symbols shown while the array element is “spinning” may be limited to avoid confusion of the player and improve aesthetic appeal of the display. In one embodiment, a reel for an activated array element 301 may be limited to positions having triggering symbols (e.g., viable for extending a symbol combination) and positions having blank symbols to make it easy for a player to visually detect extending or matching symbols. Associated reel strips (or a weighted symbol selection table) may be used that are specific to an activated array element 301 during symbol presentation that do not alter the mathematical probability of symbol selection.

Referring now to FIG. 5B, after the corresponding symbols are determined and displayed for each array element 301 of the set of initial array elements 350, the array elements 301 of the set of initial array elements are deactivated. A determination is made as to whether a set of array elements 301 of the playfield 320 displays a new predetermined symbol combination. When a new predetermined symbol combination is displayed, the new matching combination symbols 365 of array elements 360 become “locked” (i.e., array elements 360 display combination symbols 365 that remain fixed and non-changing for the duration of the wagering game).

The new predetermined symbol combination, formed by the combination symbols 365 of the array elements 360 in the initial set of array elements 350, causes the activation of a set of additional array elements 370 adjacent to the combination symbols 365. In one embodiment, the combination symbols 365 only trigger activation of adjacent array elements 301 that are not already part of an established symbol combination. The additional array elements 370 are activated due to adjacency to the matching array elements 362, while none of the array elements 360 are re-activated. Thus, the combination symbols 365 are shown thatched (deactivated) and the set of additional array elements 370 are shown non-thatched (activated) in the playfield 320. The set of additional array elements 370 await determination and display of a corresponding symbol to extend the predetermined combination formed by the combination symbols 365 as the wagering game progresses.

In one embodiment, a combination symbol 365, once a part of a predetermined symbol combination, remains fixed and ineligible for any repeated activation during an expansion of the symbol combination. That is, a combination symbol 365, once established as part of a predetermined combination, remains static during the combination expansion until symbols in additional array elements 370 fail to extend the symbol combination. In another embodiment, some or all of the combination symbols 365 may be re-activated according to various criteria. In other embodiments, the wagering game may keep a count of a particular combination symbol 365 and activate a set of expansion array elements 370 adjacent to each new combination symbol 365.

Referring now to FIG. 5C, the corresponding symbols for the additional array elements 370 shown in FIG. 5B are determined and displayed in the playfield 320. In this example, a (single) new combination symbol 365 displays a symbol that extends the symbol combination (creating a new predetermined symbol combination). In response, the adjacent additional array elements 370 are activated accordingly.

Referring now to FIG. 5D, symbols are determined for each of the activated additional array elements 370 where deactivation has not yet occurred. In this example, the displayed symbols for the additional array elements 370 include two new matching array elements 368 and a non-matching array element 369. Deactivation of the additional array elements 370 occurs after display of all the symbols for array elements 370 and determinations of whether the symbol combination has been extended. In the event that none of the symbols displayed in the additional array elements 370 do not extend the symbol combination, the iterative expansion process of the symbol combination terminates.

Referring now to FIG. 5E, a new set of activated additional array elements 370 are determined in response to the new matching array elements 368 (now combination symbols 365). The non-matching array element 369 does not extend the existing symbol combination, so no additional impact to the symbol combination or playfield occurs as a result. The iterative expansion of the symbol combination continues until additional symbols no longer extend the predetermined combination by repeatedly activating additional array elements 370 and displaying new symbols in the additional array elements 370.

The expansion of a symbol combination may be due to a wide variety of triggering events. In the abovementioned examples, new matching array elements 365 trigger adjacent additional array elements 370 to become activated that may extend beyond the initial set of array elements 350. Extending the symbol combination expansion in a particular direction may be nudged, for example, by allowing player selections of particular additional array elements 370 may bias symbol combination extending in a particular direction. The inclusion of additional displayed symbols or randomly triggered game events may also trigger activation of many additional array elements 370 simultaneously. For example, an event may trigger the activation of all array elements 301 adjacent to any combination symbol 365. Skill-based events that alter the rules of expansion, random or selected triggering events, and/or types and number of symbols in play may also be implemented to vary the activation of additional array elements 370. The rules governing symbol combination expansion and array element activation may evolve over time, from spin-to-spin, using a time-based determination, or other criteria.

Referring now to FIG. 5F, the process of extending the symbol combination continues until an outcome playfield 399 is displayed. When the symbols displayed by the additional array elements 370 no longer extend the symbol combination (i.e., no activated array elements 301 remain and no new symbol combination is formed), the outcome playfield is determined. In response to display of the outcome playfield 399, a corresponding award is evaluated.

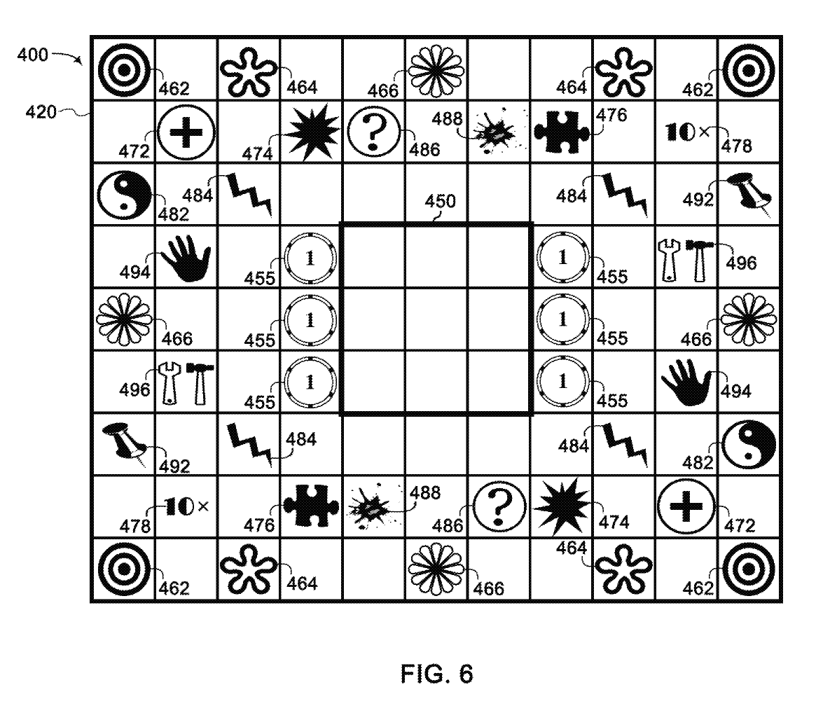

Referring now to FIG. 6, there is illustrated one embodiment an image of a game screen 400 displayed on one or more displays of an electronic wagering game machine (e.g., gaming machine 10) during a wagering game. The game screen 400 includes a playfield 420 that includes a wide variety of graphical indications corresponding to features having an impact on wagering game initialization, symbol combination expansion, award evaluations, or combinations thereof. For example, the playfield 420 includes iconic representations associated with specific array element positions triggering corresponding features of the wagering game (triggering array elements). The feature(s) triggered may occur in response to an array element being activated, a symbol combination including an array element, or some other predetermined event.

An initial wager that initiates the wagering game may be accompanied by additional wagers that add to or complement the wagering game. For example, additional wagers or payments for specific features may be required to enable playfield triggers and other events available during gameplay. In one embodiment, a player may purchase items and features available in the wagering game that includes the size of the initial set of array elements 450, the configurations and availability of triggers on the playfield 420, available re-spin features (e.g., array element activation adjacent to new expanding symbols, array element activation adjacent to all symbols of the combination, etc.), selection of the playfield 420 itself, and/or configuration of the initial set of array elements 450. In one example relating to initialization of the wagering game, array elements 455 may be purchased (i.e., by making an additional or increased wager) to increase the size of the initial set of array elements 450 during game initialization providing more activated initial array elements. That is, a basic wager may activate the initial set of array elements 450 to begin symbol combination expansion, but increased wagers may be required to include the array elements 455 as part of the initial set of array elements 450. Alternatively, the array elements 455 may indicate a one credit cash, token, or chip award to be granted to the player for each corresponding array element 455 activated during gameplay or symbol combination extending thereon.

The playfield 420 may also include graphical representations that indicate potential expansion of symbol combinations to particular array elements during the wagering game. In one embodiment, an array element 301 may trigger a predetermined specific event or gaming feature in response to activation. For example, upon activation of the array element 472, one or more array elements may become activated in an additional section of the playfield. The additional section may include array elements that increase the probability for a secondary set of array elements to merge into the current symbol combination. The additional section may include activation of additional array elements that are adjacent to one, many, or all symbols of the symbol combination. Alternatively, the array element 472 may provide the player with an option to select one or more of the initial set of array elements 450 to be re-activated. In some embodiments, extending the symbol combination may be confined to specific areas of the playfield 420, e.g., restricted corridors of array elements eligible for activation, multiple array elements being activated simultaneously, or activation of additional array elements limited to a particular direction.

An array element 474 may cause all array elements surrounding new matching array elements to become activated where only horizontally and vertically adjacent array elements are typically activated. Alternatively, the array element 474 may cause all array elements adjacent to the symbol combination to become activated, or the symbol combination to simultaneously expand in all directions. An array element 486 may trigger a randomized feature (selected from one of the above, one of the available, or one of an exclusionary group), or directly impact the value of the combination symbols (such as upgrading each symbol of the symbol combination to a higher valued symbol). Alternatively, the array element 486 may initiate a new wagering game instance with an enhanced pay table, altered symbol set, or new set of feature icons. In one embodiment, an array element 492 may allow the player to select one or more additional array elements to activate. In other embodiments, activating two separate array elements may alter the odds for symbol determination or payout for one or more array elements.

The activation of particular array elements may have a negative effect on the overall wagering game outcome. For example, consider an array element 488 that truncates the expansion of the symbol combination in a particular direction, removes one or more array elements from the combination, removes one or more array elements from the playfield 420, reduces the value of the symbols of the combination, or erects a wall or blockade in the playfield 420 to impede extending a symbol combination in the normal way.

Further, the playfield 420 may include a plurality of array elements required to trigger one or more features. In one embodiment, multiple array elements 476 must be activated in the same symbol combination expansion to trigger a specific feature. Other embodiments may include persistent array element activation over many game instances. An automatic symbol combination expansion feature or award may occur in response to a symbol combination including all array elements in the initial set, a predetermined region of the playfield, the entire playfield, surrounded, almost surrounded, or flanked empty array locations, etc.

The activation of array elements may also impact awards that the player receives as a result of the outcome of the wagering game. For example, representation of a wide-area progressive jackpot 462, a major progressive jackpot 464, and/or a minor progressive jackpot 466 may be present in the playfield 420, triggering an award of a progressive jackpot in response to activation of one or more of the corresponding array elements. The array element 486 may immediately award a random amount of credits or initiate a picking-based feature granting or offering specific awards in response to a player selecting one or more indicia. An array element 478 may result in an award multiplier for a payout amount of the symbol combination or entire final outcome, and increasing the corresponding award amount proportionally. In one embodiment, the location of an array element 478 is randomly determined on the playfield 420 at the initiation of the casino wagering game. Other embodiments may include fixed, migrating, or duplicate array elements 478, each contributing to payout values for symbol combinations that extend to one or more of the array elements 478.

Other array elements may trigger combinations of these features and/or additional features that span multiple aspects of the wagering game. For example, an array element 482 may result in a combination of positive and negative impacts, an array element 484 may trigger all array elements to randomly determine a new symbol, an array element 494 may grant the player a choice to receive an increased award for stopping the wagering game before a random outcome is determined, and/or an array element 496 may allow the player to modify one or more aspects of the wagering game including theme, music, other setting, pay table, symbol set, etc.

The graphical indications of awards and feature triggers may be expressly specified on a map of special or desired locations of the playfield, or alternatively, be kept hidden. Further, symbols extend a symbol combination, the associated array elements may reveal underlying imagery used for other gaming features, e.g., treasure maps or pick fields. For example, a map of the playfield 420 may be made available (perhaps as a result of an award) showing special or desired array elements of the playfield 420. The map may additionally indicate the location of special or hidden array element triggers in the playfield 420 (e.g., a pirate's treasure).

Feature triggers may also include different awards based on symbol combination expansions in different directions, e.g., expanding to the right may increment a multiplier and expanding to the left may increment a number of free spins, while a combined award may include a choice of volatility for a bonus game.

Other predetermined conditions or events may trigger any of the above (or additional) features of the wagering game. For example, a feature may occur in response to a predetermined number of symbols in the symbol combination, an overall dimension or configuration of the symbol combination (including length of vertical, horizontal, and/or diagonal extensions, or predefined symbol combination shapes), a predetermined symbol on one or more reels being displayed, activating or a symbol combination including a randomly migrating array element in the playfield, etc. As mentioned, triggered feature events may include a partial or full re-spin of adjacent array elements of the playfield, upgrading symbols and/or value amounts for one or more symbols, array elements, or symbol combinations, initializing a new initial set of array elements in the playfield in a new gaming instance, awarding a progressive jackpot, etc. Watermarked symbols on the playfield may also be used to enhance and improve the wagering game, for example, by providing an award for collecting specific watermarks or symbols, or by triggering symbol combination expansion in a particular direction or including a plurality of playfield locations. Additional features may be an integrated part of the wagering game, for example, revealing underlying segments of the playfield to conduct a “concentration-style” rebus, maze, or other visual-based puzzle, adding a skill-based element to a subsequent player award.

### Evaluation

In response to an outcome 399 of a playfield 320 during the wagering game, an evaluation takes place to determine an associated award corresponding to the outcome 399 and, perhaps, trigger additional gaming features. In one embodiment, each array element of a symbol combination is assigned a specific value used to evaluate an award amount by accrual. In other embodiments, a value for each symbol (or symbol combination as a whole) is determined, based on the symbol type, a number of symbols in the combination, and/or a location in the playfield 320 of the array element 301 displaying the symbol. Specific configurations or sequences of symbols may award additional amounts, for example, based on the shape (e.g., each 2×2 or 3×3 block) or a dimension of linear expansion measurement (e.g., vertical, horizontal, diagonal) of the symbol combination array elements. Awards may result from a symbol combination achieving a predetermined shape on the playfield and/or including a predetermined set of symbols. Additionally, multiple array elements may be required to achieve a predetermined symbol combination, e.g., activating or matching multiple “multi-part” array elements of the playfield.

The probability of a particular symbol combination occurring on the playfield may be tied to the specific award amount assigned to a respective symbol combination. For example, sequences of diagonal symbols may be assigned an award corresponding to the probability of occurrence. In one embodiment, larger expansions will generally provide increased value evaluation and may additionally include award multipliers, jackpots, etc., as distance from an initial set of array elements increases.

Awards may include credit amounts, additional games, gaming features, game levels, re-initialization of the playfield having higher award values, establishing a new set of initial array elements on a new playfield, simultaneous multiple initial arrays on the current or a new playfield, etc. Awards may also include inclusion or exclusion of items or attributes in a list to facilitate additional features, such as obtaining cards for a poker hand (and awarding a progressive jackpot in response to a Royal Flush), eliminating Clue™-game suspects, weapons, and rooms to award a progressive jackpot or conduct a bonus game (e.g., a Clue™ themed including player selection of indicia of a “killer”, “weapon”, and “room” to win prizes).

Evaluations may also include awards that persist across subsequent wagering games or gaming features. For example, the overall size of a symbol combination may dictate a size for a set of initial array elements in a subsequent feature. For example, a symbol combination having an overall height of two and a width of four may initiate a 2×4 set of initial array elements for another symbol combination expansion attempt. Symbol combinations (and/or random events) may trigger awards that include a prize-based reel/wheel overlying the symbol combination expansion region. Evaluation may trigger specific award determination features, for example, the array elements of the symbol combination in the playfield becoming a pick field allowing a player to select for a chance at a multiplier or other awards.

Other types of persistent gaming options may also be implemented. The collection of symbols, items, and/or locations using array elements of a playfield may enable additional games to conduct scavenger hunts, complete checklists, etc., over time and one or more subsequent games. Prizes may be awarded to players having the highest score, most feats achieved, etc. accrued during the allotted time or games. Alternatively, benchmarks may trigger specific awards for session players. Collected or gathered symbols, watermarks, locations, etc., may remain persistent during a gaming session or be persistently stored in a player-based account. When completed or triggered, awards or feature events may be conducted.

Awards may include parameters or features offered in one or more additional award games aside from the original wagering game. For example, activation of array elements on a playfield may cause addition (or removal) of pins on a pachinko playfield, pachinko balls to be cast in parallel or subsequently, and/or establishment of award amounts for one or more pachinko receptacles. Further, the outcome of a base game using the symbol combination expansion as detailed may initiate bonus games or additional games having specific initial conditions based upon the outcome.

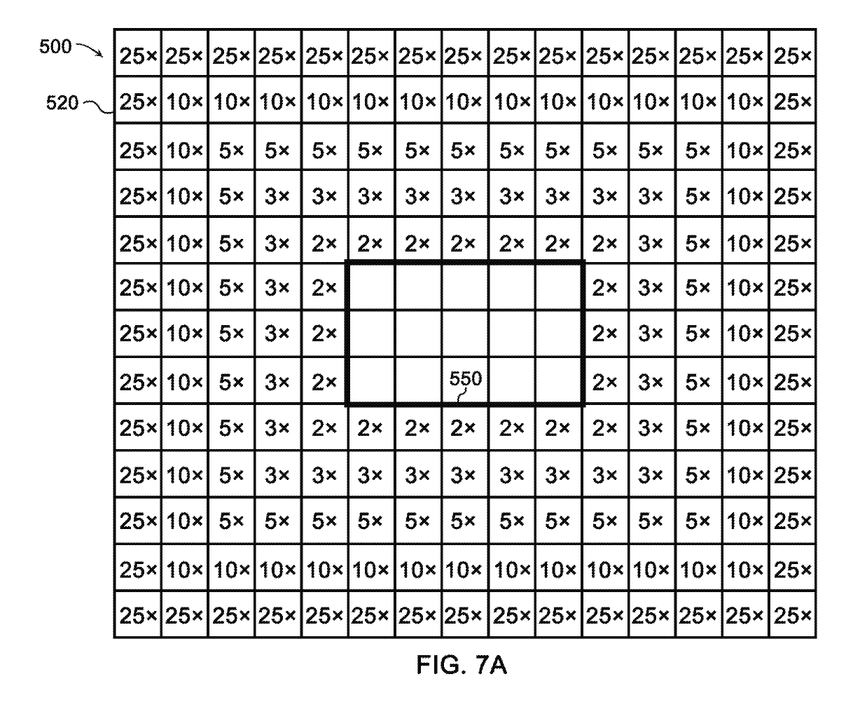

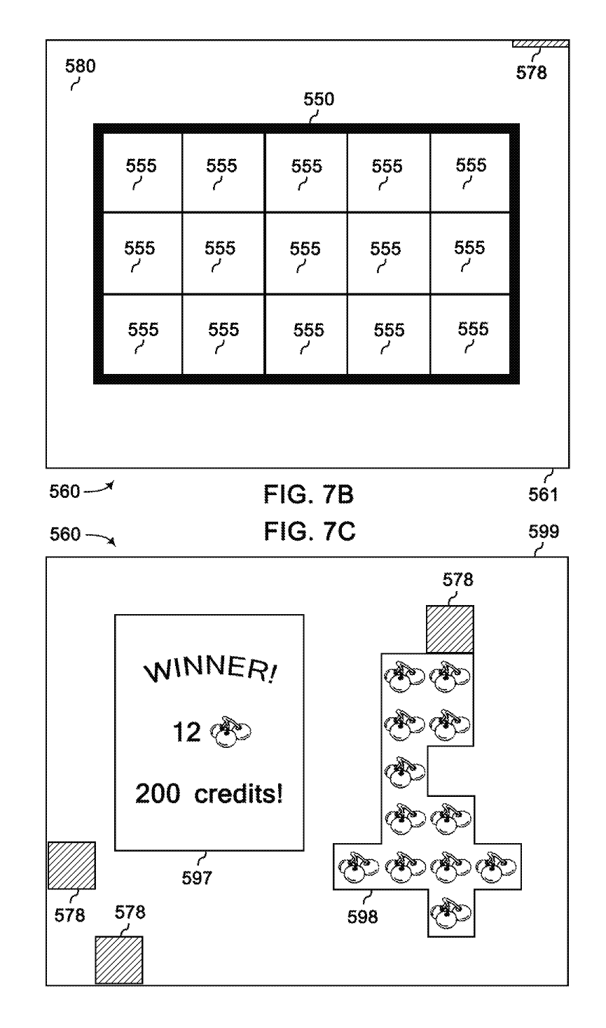

Referring now to FIG. 7A, there is illustrated an image of a game screen 500 displayed on one or more displays of an electronic wagering game machine (e.g., gaming machine 10) during a wagering game in one embodiment. The game screen 500 includes a playfield 520 that includes a set of concentric rings of array elements that surround an initial set of array elements 550. Each of the array elements outside the periphery of the initial set of array elements 550 has an associated multiplier having a predetermined multiplier value. As a symbol combination occurs to include one or more of the array elements having an associated multiplier, the associated award corresponding to the symbol combination may be adjusted in accordance with the multipliers included in the symbol combination.

In one embodiment, the highest achieved multiplier is used to adjust the award of the symbol combination accordingly as a playfield outcome is determined. Thus, a symbol combination expansion that includes a 3× and a 5× multiplier array element may result in a 5× multiplier value adjustment to the award amount for the symbol combination. In another embodiment, plural multipliers may be conjoined into a single multiplier value. For example, as the symbol combination is extended to include additional multipliers, a combined multiplier may be determined based upon the additional multipliers. The combined multiplier may be additive (such that a 3× and 5× multiplier become an 8× combined multiplier), or multiplicative (such that a 3× and 5× multiplier become a 15× combined multiplier. In other embodiments, a predetermined number of array elements having a common associated multiplier may be required to adjust the award amount accordingly. For example, a 3× multiplier is awarded in response to the symbol combination including a total of three 3× array elements.

Referring now to FIG. 7B, there is illustrated an image of a game screen 560 displayed on one or more displays of an electronic wagering game machine (e.g., gaming machine 10) during a wagering game in one embodiment. The game screen 560 includes a playfield viewport 561 of the playfield 580. The viewport 561 graphically displays at least a section of the playfield 580 of the wagering game on the game screen 560 that emphasizes the initial set of array elements 550. The playfield 580 includes a full view of the initial set of array elements 550 comprised of a set of array elements 555 that are activated upon initiation of the wagering game as detailed prior.

In one embodiment, one or more of a set of feature array elements 578 are highlighted at the initialization of the wagering game as displayed in the viewport 561. The feature array elements 578 may trigger one or more features during the wagering game, for example, award multipliers or additional expansion. Additional feature array elements 578 may be part of the playfield 580 that are not currently displayed as part of the viewport 561 (e.g., see FIG. 7C). In one embodiment, the viewport 561 may zoom in and zoom out of various sections of the playfield 580 to display only the most relevant visual content in an aesthetic manner. For example, the viewport 561 may display the initial set of array elements 550 enlarged at game initiation to fill the viewport 561 (as shown), and modify the viewport 561 to display matching symbols and activated array elements as the wagering game progresses. The visual shifting of the viewport 561 may cause one or more feature array elements 578 to be (temporarily) excluded from view during portions of the wagering game. As a combination of matching symbols expands (e.g., as additional array elements display matching symbols of a combination), the viewport 561 may dynamically change in size and perspective, for example, to alternate between displaying the entire symbol combination and a focused region of activated array elements. That is, as additional symbols become part of the predetermined symbol combination, the viewport 561 may change to accommodate and emphasize the additional symbols and the ongoing process of symbol combination expansion.

In one embodiment, the number of the feature array elements 578 and the location of the feature array elements 578 in the playfield 520 are randomly determined during initiation of the wagering game. For example, the number of feature array elements 578 may be based on one or more random elements, and the probability of an additional feature array element 578 may increase with each determined or displayed feature array element 578. Further, the location of a feature array element 578 may be randomly determined such that the probability of the presence of a feature array element 578 is based upon a distance from one or more of the set of initial array elements 550. In another embodiment, one or more of the number of the feature array elements 578 and/or the location of the feature array elements 578 in the playfield 561 are fixed and remain consistent from wagering game instance to wagering game instance. In yet another embodiment, the feature array elements 578 are not highlighted and the results of an array element 578 activation may occur without any notice to the player.

In one embodiment, the array elements 555 of the initial set 550 are randomly determined and a symbol combination may be displayed. As additional array elements are activated, the symbol combination may expand as detailed prior. In the event that one or more of the feature array elements 578 are activated or become part of a symbol combination, corresponding features are performed or applied for the execution, gaming outcome, or associated payout of the wagering game, either immediately or upon completion of the wagering game.

Referring now to FIG. 7C, there is illustrated an image of a game screen 560 displaying a game outcome viewport 599 displayed on one or more displays of an electronic wagering game machine (e.g., gaming machine 10) during a wagering game in one embodiment. At the conclusion of a wagering game, the game outcome viewport 599 displays an outcome dialog box 597 and the outcome symbol combination 598 displaying the symbols of array elements determined during the wagering game (including array elements in the initial set 550 and additional array elements outside the initial set 550). The outcome dialog box 597 displays a result of the outcome of the wagering game, for example, details of the outcome symbol combination 598 and a corresponding payout award. The outcome dialog box may also display details of the impact of the activation and/or presence of one or more feature array elements and corresponding symbols.

The dialog box 597 may be selectively positioned in the viewport 599 so as not to interfere with the outcome symbol combination 598. Further, the viewport 599 may change size and/or perspective to highlight and display the symbol combination 598 while dynamically positioning the dialog 597 so as not to interfere with display and presentation. As the expansion of a symbol combination continues, activated array elements may migrate in a particular direction leaving one or more areas of the playfield 580 unused. The size and positioning of the viewport 561, 599 may be changed to accommodate expanding symbol combinations and resulting dialog boxes. In one embodiment, the dialog box 597 is placed as an overlay to the viewport 599 and positioned relative to the outcome symbol combination 598.

### Conducting the Wagering Game

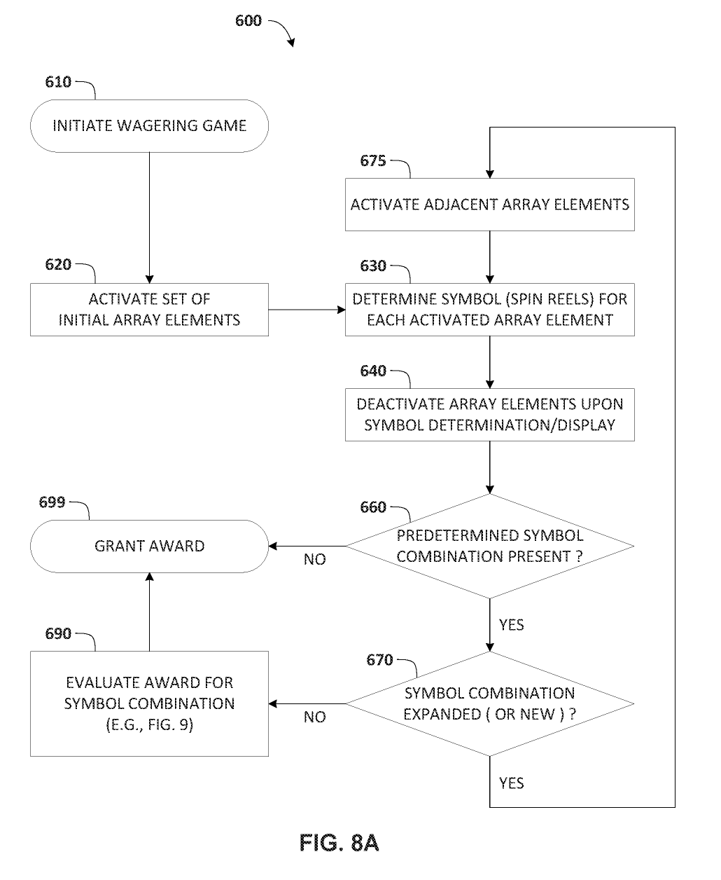

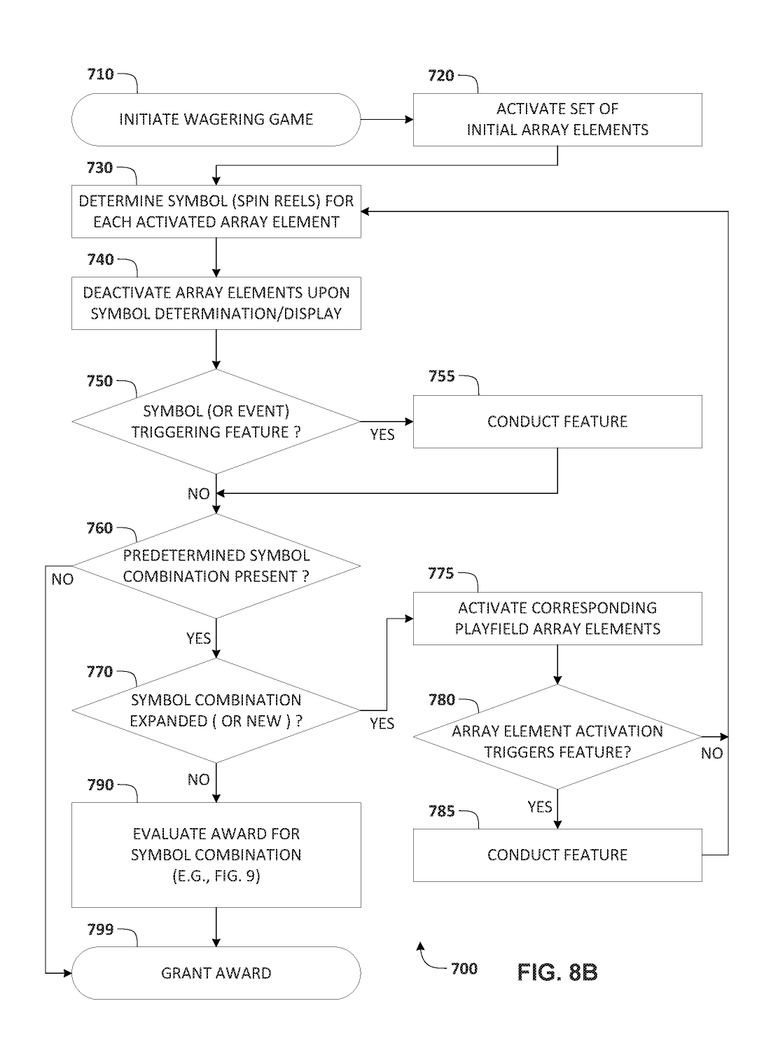

Referring now to FIG. 8A, a data-processing computer-implemented method 600 for conducting a wagering game is shown for one embodiment. The process begins with the initiation of the wagering game in step 610. This may occur in response to a wager being accepted and deducted from a player account balance, credit meter, or submitted monetary article. Alternatively, a wagering game feature may be initiated by a triggering event in a distinct wagering game feature that follows the outline of method 600.

In step 620, an initial set of array elements are designated for a playfield and each of the initial set of array elements are activated. As detailed prior, each activated array element will have a corresponding symbol randomly determined and displayed for the array element prior to being deactivated.

In step 630, a corresponding symbol is determined and displayed at each of the activated array elements. This may involve the use of random elements that are mapped to a set of symbols via an actual, virtual, or table-based reel strip, or use of a weighted lookup table. The use of independent reel strips for each of the active array elements, or a collective reel strip providing symbol-based outcome to multiple active array elements simultaneously are both possible, as are other methods of determining symbols for the activated array elements.

In step 640, the activated array elements (now with determined and displayed symbols) are deactivated. In many embodiments, a deactivated array element does not preclude the potential for re-activation based on future determinations. In some embodiments, the determination and display of a symbol immediately deactivates the array element. In other embodiments, the array element may have a symbol determined and displayed again until one or more criterion are met. In further embodiments, the activated array elements are not deactivated until further determinations are made (e.g., step 660).

In step 660, a determination is made as to whether a predetermined symbol combination is present in the array elements of the playfield. As outlined prior, this determination may include, for instance, the use of a pay table of predetermined symbol combinations and/or an algorithm for determining whether the symbols displayed at the array element locations of the playfield meet a predetermined criterion for award. In the event that array elements and/or symbols of the playfield dictate the activation of additional array elements, further determinations must be made.

In step 670, a determination is made as to whether the symbol combination present in the playfield has expanded. For example, a symbol combination that was previously presented may have additional symbols that extend the symbol combination. This includes an initial “expansion” of an entirely new symbol combination. If so, a process of determining appropriate array elements of the playfield for activation (and subsequent symbol determination and display) may be required. In one embodiment, a new symbol extending a symbol combination triggers the activation of adjacent array elements that are not already part of the symbol combination. In another embodiment, extending the symbol combination activates all array elements adjacent to any array element of the symbol combination.

In step 675, when it is determined that an expanded symbol combination has been made, a process for determining and activating new additional array elements takes place. In the current embodiment, any array element directly adjacent to a new symbol of the newly formed symbol combination becomes activated. In other embodiments, the process for determining additional array elements may be much more complicated, and may use elaborate rule sets and/or algorithms to determine which, if any, additional array elements of the playfield to activate.

Noting that activated additional array elements are designated to have a corresponding symbol determined and displayed, the process of determining a symbol for each activated additional array element (step 630), deactivating additional array elements with displayed symbols (step 640), and determining whether the symbol combination has been extended (i.e., contains new array elements/symbols) (step 670) repeats until the symbols determined for the activated additional array elements fail to extend the symbol combination.

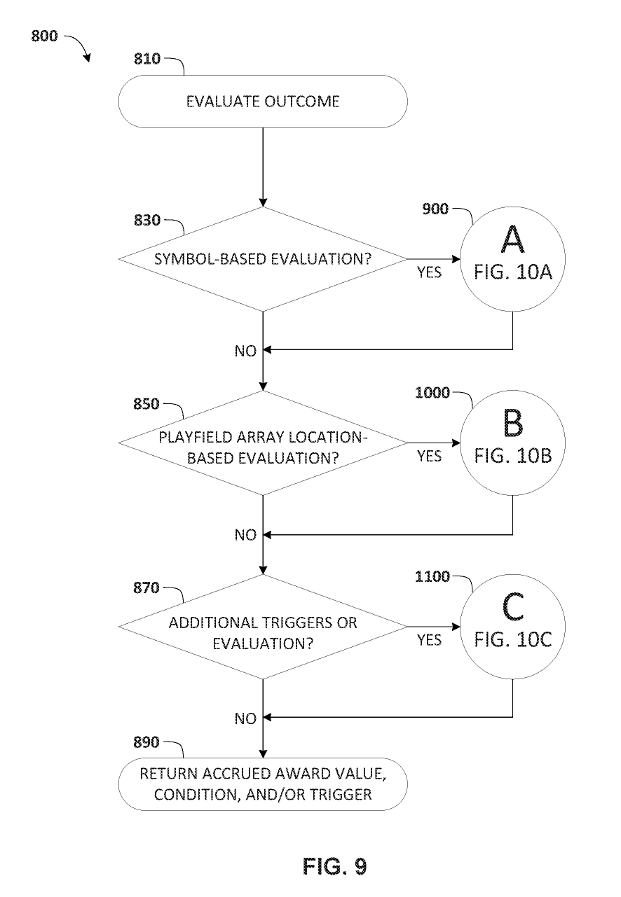

In step 690, in response to the failure of extending a symbol combination (a determination of “NO” at step 670), a symbol combination outcome is determined. An evaluation occurs using the symbol combination outcome to determine a corresponding award. As detailed prior, evaluation of the playfield and symbol combination may use a wide variety of functional and deterministic processes to ascertain a corresponding award. One embodiment of evaluation is set forth in upcoming FIG. 9.

In step 699, once an evaluation is determined for a symbol combination of the playfield or it is determined that no predetermined symbol combination is present in the playfield (a determination of “NO” at step 660), a corresponding award is granted for the outcome.

Referring now to FIG. 8B, one embodiment of a data-processing computer-implemented method 700 for conducting a wagering game having additional features is shown. The process begins with the initiation of the wagering game in step 710. This may occur in response to a wager being accepted and deducted from a balance established in a player account, credit meter, or in response to a submitted or detected monetary article.

In step 720, an initial set of array elements are designated and each of the initial set of array elements become activated. As detailed prior, each activated array element will have a corresponding symbol determined and displayed for the array element.

In step 730, a corresponding symbol is determined and displayed at each of the activated array elements. This may involve the use of random elements that are mapped to a set of symbols via an actual, virtual, or table-based reel strip utilizing one or more of the random elements. The use of independent reel strips for each of the active array elements, or a collective reel strip providing a symbol-based outcome to multiple active array elements simultaneously are both possible, as are other methods of determining symbols for activated array elements.

In step 740, the activated array elements become deactivated following the determination of a corresponding symbol and display of the symbol. A deactivated array element does not necessarily preclude the potential for re-activation based on future determinations even if the displayed symbol extends a symbol combination.

In step 750, a determination is made as to whether a feature has been triggered by one or more of the symbols generated for the most recent activated array elements, a symbol combination that includes a symbol of one or more of the most recent activated array elements, or by a random event.

In step 755, if it is determined that a feature has been triggered, the feature is performed. Triggered features, as detailed prior, may include automatic and/or random symbol population for one or more array elements of the playfield, player selection of array elements to become activated, granted awards, etc. Alternatively, in a different embodiment, a triggered feature may be deferred until the expansion of the symbol combination completes. Thus, after a predetermined triggering event, a symbol combination expansion may continue to be extended until no new symbols contribute to the symbol combination (i.e., the symbol combination ceases expanding), and then a corresponding feature event takes place. In other embodiments, one or more gaming features may be deferred until an event takes place, such as a criterion being determined and fulfilled.

In step 760, a determination is made as to whether a predetermined symbol combination is present in the array elements of the playfield. As outlined prior, this determination may include, for instance, the use of a pay table of predetermined symbol combinations and/or an algorithm for determining whether the symbols displayed at the array element locations of the playfield meet predetermined award criteria (i.e., a winning symbol combination predefined in a pay table). In the event that array elements and/or symbols of the playfield dictate the activation of additional array elements, further determinations must be made.

In step 770, a determination is made as to whether the symbol combination present in the playfield has been extended or expanded due to the most recently determined activated array elements. This includes the initial “expansion” of an entirely new symbol combination. If so, a process of determining appropriate array elements of the playfield for activation (and subsequent symbol determination and display) is required. In one embodiment, a new symbol extending a symbol combination triggers the activation of each array element adjacent to the array element containing the new symbol, provided the array element is not already part of the previously presented symbol combination. In another embodiment, extending the symbol combination activates all array elements adjacent to any of the array elements of the symbol combination.

In step 775, when it is determined that a symbol combination is extended and presented, a process for determining and activating corresponding new array elements is performed. In one embodiment, any array element directly adjacent to a new symbol of the symbol combination is activated. In other embodiments, the process for determining activated array elements may be much more complicated, and may use elaborate rule sets and/or algorithms to determine which, if any, array elements of the playfield to activate.

In step 780, a determination is made as to whether the activation of any of the array elements determined in step 775 (or other event) triggers a feature. Other events, such as a randomly determined trigger based upon the new combination, may also occur be considered in the determination. If so, corresponding feature(s) are suitably conducted in step 785 or scheduled for performing at a later time. As detailed prior, features may include activating additional array elements, removing activated array elements, triggering awards to be granted, symbol population in one or more array elements, conducting additional gaming features, etc. In accordance with any triggered features, the effects and results of the features are accounted and implemented.

Once any additional triggered features are conducted or scheduled, the repeating process of determining a symbol for each activated array element (step 730), deactivating array elements having symbols determined and displayed (step 740), triggering and conducting additional features (steps 750-755), determining whether the symbol combination is extended or has expanded (step 770), and accordingly activating array elements and triggering, conducting, and/or scheduling gaming features (steps 775-785), continues until the playfield obtains a final outcome. In one embodiment, a final outcome for a playfield is achieved when symbols determined for the activated array elements and any additional features fail to extend the symbol combination.

In step 790, in response to the failure of a symbol of an activated array element to extend or expand the symbol combination (a determination of “NO” at step 770), a symbol combination outcome is determined. An evaluation occurs using the symbol combination outcome of the playfield to determine a corresponding award. As detailed prior, evaluation of the playfield and symbol combination may use a wide variety of functional and deterministic processes to ascertain a corresponding award. One embodiment of evaluation is set forth in upcoming FIG. 9.

As mentioned prior, one or more features or feature events may be selectively deferred until the expansion of the symbol combination has completed (i.e., “NO” in step 770) and/or a “final” playfield outcome has been generated. Thus, prior to the evaluation of the playfield outcome (e.g., generated via symbol expansion and corresponding features), one or more wagering game features may be conducted. These deferred features may impact the evaluation of awards for symbol combinations present in the playfield outcome or may be conducted as completely separate and distinct events of the wagering game.

In step 799, once an evaluation is determined for a symbol combination of the playfield or it is determined that no predetermined symbol combination is present in the playfield (a determination of “NO” at step 760), a corresponding award is granted for the symbol combination and outcome playfield. It is noted this may also happen as a result of one or more features conducted during any portion of the wagering game.

Referring now to FIG. 9, one embodiment of a data-processing computer-implemented method 800 for evaluating the outcome playfield and symbol combinations of a wagering game conducted in accordance with the previously described methodology is shown. Other embodiments may include different and additional orders of operations, additional processes, additional evaluation types, and/or other criteria that drive decision making in accordance with the particular embodiment. FIG. 9 is an overview of an evaluation process in accordance with one embodiment of the wagering game as generally described in FIGS. 3-7. An evaluation for a wagering game or symbol combination outcome begins with a request for (e.g., software function call) and initiation of an evaluation process (e.g., from step 690 or step 790 in FIGS. 6-7 respectively), in step 810.

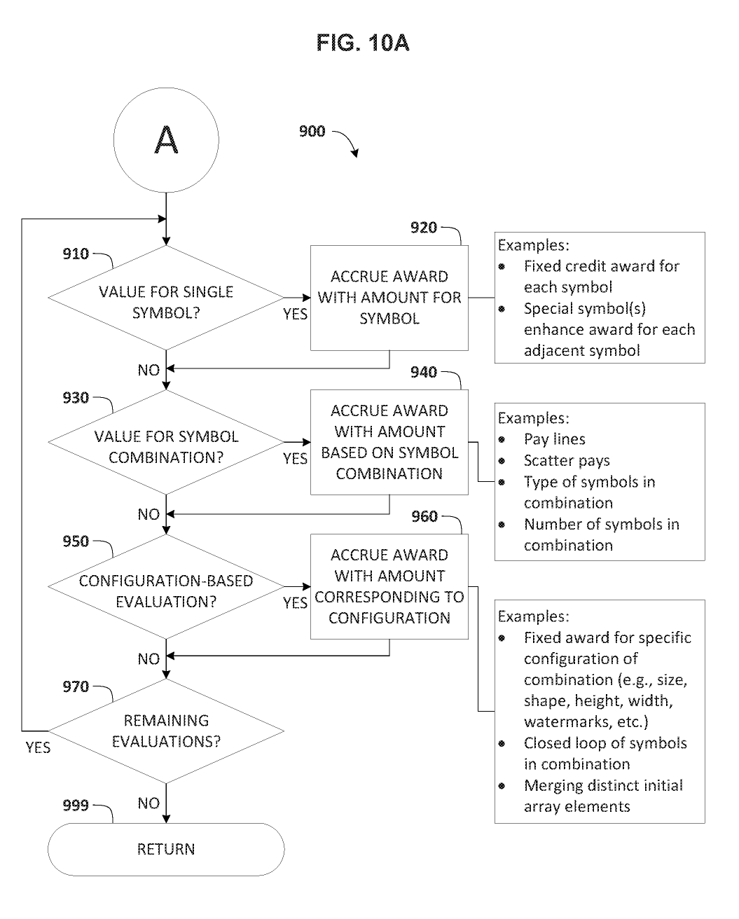

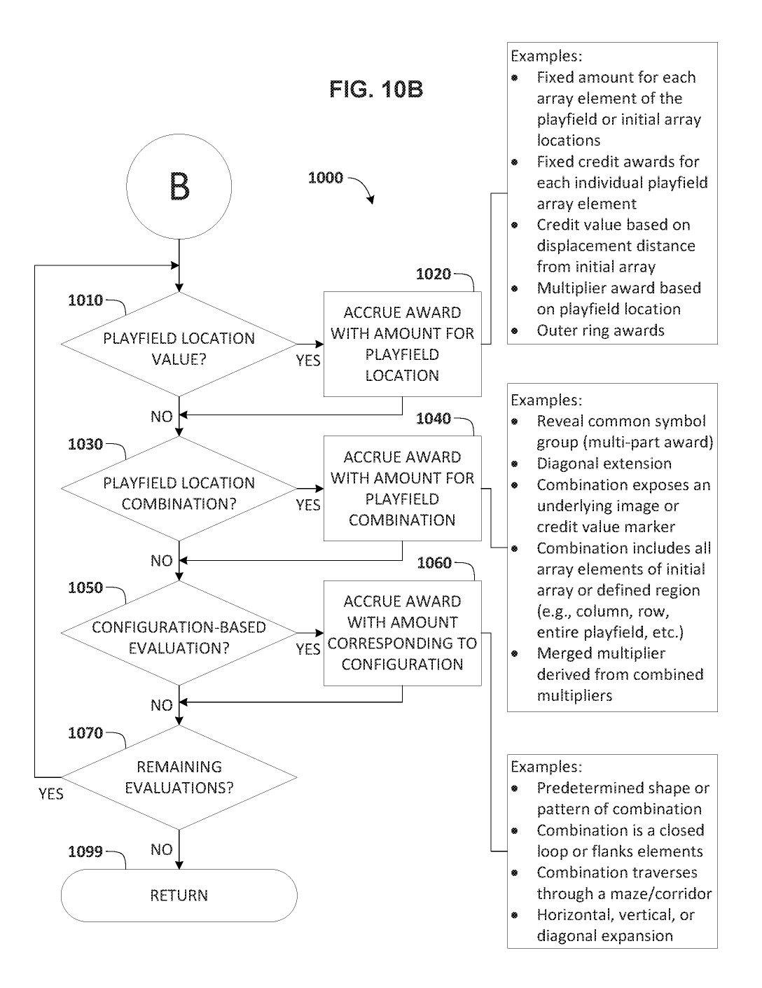

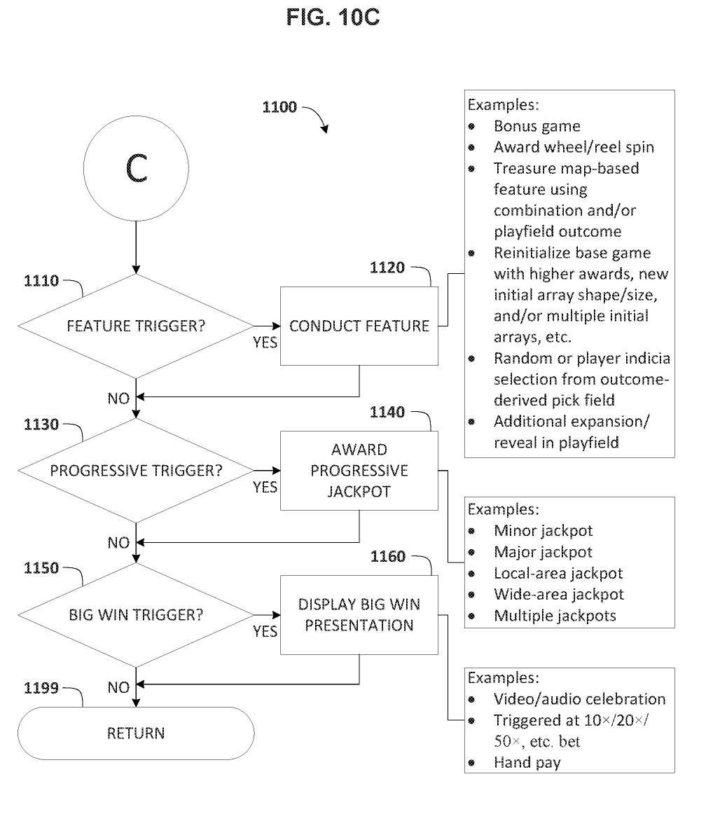

In step 830, a determination is made as to whether a symbol-based evaluation applies to the outcome playfield or symbol combination. A symbol-based evaluation may include determining awards dependent upon one or more symbols or types of symbols in the outcome playfield or symbol combination. If so, a symbol-based evaluation process 900 is conducted as set forth below in FIG. 10A.

In step 850, a determination is made as to whether an array location-based evaluation applies to the outcome playfield or symbol combination. A location-based evaluation may include determining awards dependent upon the location of one or more array elements of the outcome playfield or symbol combination. If so, a location-based evaluation process 1000 is conducted as set forth below in FIG. 10B.

In step 870, a determination is made as to whether any additional triggers or evaluations apply to the outcome playfield or symbol combination. Examples of additional triggers and evaluations include triggering one or more progressive jackpots, conducting additional features, conducting special “big win” celebrations or multimedia presentations in response to the achieved outcome playfield, etc. If so, a corresponding process 1100 is conducted as set forth below in FIG. 10C.

In step 890, the results of the evaluation process 800 are returned upon completion of the corresponding evaluations and determinations. This may include indication of a total award value (e.g., for display or hand-pay requirements), indications of achieved milestones, triggers for additional processing or gaming events, etc.

Referring now to FIG. 10A, one embodiment of a symbol-based evaluation process 900 is described. The symbol-based evaluation process 900 may be performed in response to the need for an evaluation that takes into account the specific symbol or symbols that comprise a symbol combination in the playfield.

In step 910, a determination is made as to whether there is an associated award value for an individual symbol of a playfield outcome or symbol combination. Examples may include fixed credit amounts for individual symbols of a symbol combination, credit-awarding symbols, symbols or events that trigger awards based on symbols in the combination or playfield, etc.

In step 920, if an individual symbol of the symbol combination has an associated award or award value, the award(s) (e.g., amount, prizes, etc.) are determined based on the individual symbol. In many embodiments, a running award total is accrued prior to a determination of the total award amount.

In step 930, a determination is made as to whether there is an associated award value for one or more predetermined symbol combinations of the playfield outcome. Examples may include sets of symbols considered together to grant an award including but not limited to, pay lines, symbol frequency, symbol-based scatter pays, etc.

In step 940, if a symbol combination has an associated award, a corresponding award is determined based on specifics of the symbol combination. An award amount may be accrued to a running total of an award for the playfield or symbol combination as a whole.

In step 950, a determination is made as to whether there is a configuration-based evaluation for one or more symbol combinations or the playfield as a whole. Examples include sets of symbols positioned in array elements arranged in a specific way (e.g., shape of symbol combination), awards based on one or more dimensions or extent of symbol combination expansion, merged sets of symbol combinations or initial array elements, etc.

In step 960, if a configuration-based symbol combination has an associated award, a corresponding configuration-based award is determined based on the symbol combination or configuration of playfield array elements. The award amount is tabulated and accrued in accordance with the overall waging game evaluation.

In step 970, in the event further or additional evaluations are required, the flow of process 900 returns to step 910 for repeated evaluation processing, for example, to determine awards for additional symbols, symbol combinations, or overlapping symbol combinations.

In step 999, all symbol-based evaluations are completed and the process 900 ends. In one embodiment, an amount of the determined award(s) are returned to the calling programmatic procedure having a specific value or indication of the determined award(s).

Other embodiments may include decisions for a playfield array or symbol combination symbol-based evaluation process 900 that include other types of symbol-based criteria and award determinations that are not suggested or expressly recited. An artisan will recognize a wide variety of alternative embodiments that do not depart from the overall spirit and scope of the invention.

Referring now to FIG. 10B, one embodiment of a symbol combination or playfield array location-based evaluation process 1000 is described. The location-based evaluation process 1000 may be performed in response to the need for an evaluation based upon a location of one or more array elements of the playfield having an associated award. Other examples may include the use of watermarks assigned to one or more array elements of the playfield that comprise award criteria, randomly determined playfield migrating awards, multi-locational playfield array element awards, etc.

In step 1010, a determination is made as to whether there is an award value associated with one or more locations of the playfield corresponding to displayed array elements that are part of a symbol combination. Examples include awards values (e.g., credits and/or multipliers) statically assigned to one or more locations of the playfield, awards based on a distance from a fixed array element, “outer ring” awards, etc.

In step 1020, if a location of the playfield has an associated award or award value, the awards are determined based on the respective locations of the array elements of the symbol combination.

In step 1030, a determination is made as to whether there are array elements in one or more symbol combinations of the playfield that must be considered together to grant an associated award. Examples include sets of symbols of the playfield that may be considered in combination to grant an award including but not limited to, collection of multiple array elements, symbols present in or activating predetermined sets of playfield array elements, merging of multiple array elements awards into a single award, etc.

In step 1040, if a combination of array elements may be considered to grant an award, a corresponding award is determined for each combination of array elements of the symbol combination. In some embodiments, multiple awards may result from a specific symbol combination, e.g., an award for each distinct pair of three distinct symbols.

In step 1050, a determination is made as to whether there is a configuration-based evaluation required for one or more symbol combinations of the playfield. Examples may include array elements arranged in specific shapes or formations, awards based on combination expansion, etc.

In step 1060, when configuration-based award criterion are fulfilled, a corresponding configuration-based award is determined based on the symbols and symbol combinations of the playfield.

In step, 1070, when further or additional evaluations are required, the flow of process 1000 returns to step 1010 for repeated evaluation processing, for example, to determine awards for additional symbol combinations, overlapping symbol combinations, etc.

In step 1099, when all configuration-based evaluations are completed, the process 1000 terminates. An amount indicating the determined awards may be returned to another programmatic function or program.

Other embodiments may include decisions for a playfield array location-based evaluation process 1000 that involve other types of location-based criteria and award determinations other than those suggested or expressly recited here. An artisan will recognize a wide variety of alternative embodiments that do not depart from the overall spirit and scope of the invention.

Referring now to FIG. 10C, a trigger and additional evaluation process 1100 is described in one embodiment. The evaluation process 1100 may be performed in response to the triggering of progressive jackpot awards, the determination of an award above a minimum hand-pay threshold, when an additional gaming feature is triggered, etc. In short, for any follow-up processing to determine one or more awards for the wagering game, to formally complete the wagering game, or to effect some special programming or presentation of the wagering game, the evaluation process 1100 provides a way to systematically determine and process wagering game finalization. Additional or alternative procedures may also be implemented that do not depart from the overall spirit and scope of the invention.

In step 1110, a determination is made as to whether an additional gaming feature was triggered as a result of a criterion present in the playfield outcome or the wagering game. Additional gaming features may be a result of a predefined trigger (e.g., symbol constituent or symbol combination), a randomly determined event, a community feature triggered by events that involve collectively connected, banked, or eligible gaming machines, promotional offerings, etc.

In step 1120, if an additional feature or features are triggered, the corresponding feature or features are conducted. In certain circumstances, this may involve re-evaluating the playfield outcome, symbol combination(s), and/or an already tabulated award amount, when such evaluations are required. Alternatively, the award(s) obtained in an additional feature may be completely independent from the base or bonus wagering games. An additional feature may also use the playfield outcome as a basis for additional feature or game initialization, e.g., using the locations of the playfield included in symbol combinations as a window to view a rebus, maze, or other event.

In step 1130, a determination is made as to whether a progressive jackpot has been triggered as a result of the playfield outcome or symbol combination. A progressive jackpot, whether a minor jackpot, major jackpot, local-area jackpot, wide-area jackpot, etc., may be triggered in a number of ways, including but not limited to the inclusion of a specific location of the playfield in a symbol combination, activation of a playfield location, random event independent from a base or bonus game, a predetermined number of symbols in a symbol combination, etc.

In step 1140, in response to triggered progressive jackpot(s), the jackpot(s) are awarded to the player. Special presentations and/or procedures may be used in accordance with each award, jurisdictional requirements, and celebratory results, among others.

In step 1150, a determination is made as to whether a “big win” has occurred, e.g., an award has resulted that is above some multiple of the present wager (5× wager, 10× wager, 100× wager, etc.). Varying levels of awards may constitute different big-win celebrations, and jurisdictionally, a hand-pay process may be required at a given amount that requires an attendant of the wagering establishment to actively verify and grant an award.

In step 1160, one or more big-win celebration presentations are displayed to the player on the wagering game machine in accordance with the level of the big-win trigger. Video, audio, and tactile feedback may be provided, in addition to involvement of facilities where the gaming machine is physically located.

In step 1199, when all additional processing and presentations have concluded, the process 1100 terminates. In one embodiment, the wagering game concludes and the wagering game machine returns to an attraction mode inviting players to place a wager.

Other embodiments may include decisions for additional features, triggers, and presentations 1100 that are not suggested or expressly recited, as well as a difference in the order of processing and details of operational procedures. An artisan will recognize a wide variety of alternative embodiments that do not depart from the overall spirit and scope of the invention.

FIGS. 8A-8B, FIG. 9, and FIGS. 10A-10C, described by way of example above, represent portions of an overall algorithm that corresponds to at least some instructions stored and executed by the game-logic circuitry 40 in FIG. 2 to perform the above described functions associated with the disclosed concepts.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system, comprising:
a regulated gaming machine primarily dedicated to playing at least one casino wagering game, the gaming machine including an electronic display device and one or more electronic input devices; and
game-logic circuitry configured to:
detect, via at least one of the one or more electronic input devices, a physical item associated with a monetary value that establishes a credit balance and initiate a casino wagering game in response to an input indicative of a wager covered by the credit balance;
in response to initiating the casino wagering game, direct the electronic display device to display a playfield for providing symbol-bearing array elements;
direct the electronic display device to display randomly selected initial symbols in a plurality of respective initial array elements of the playfield;
in response to a predetermined combination of the initial symbols, direct the electronic display device to iteratively display additional symbol-bearing array elements separate from the initial array elements, and present randomly selected additional symbols in the respective additional symbol-bearing array elements of the playfield until the additional symbols no longer extend the predetermined combination, wherein at least one instance of the iterative displaying of additional symbol-bearing array elements occurs after at least one of the randomly selected additional symbols has been presented;
increment the credit balance with an award amount corresponding to an evaluation of the final playfield outcome; and
receive, via at least one of the one or more electronic input devices, a cashout input that initiates a payout from the credit balance.

2. The gaming system of claim 1, wherein in response to an additional array element being a predetermined feature-triggering array element of the playfield, direct the electronic display device to display a feature of the casino wagering game corresponding to the predetermined feature-triggering array element.

3. The gaming system of claim 1, wherein the electronic display device displays the additional symbols of the additional symbol-bearing array elements of the playfield as one of blank symbols or symbols viable for extending the predetermined combination.

4. The gaming system of claim 1, wherein in response to an additional symbol-bearing array element having an award multiplier associated therewith, increasing the award amount in accordance with the award multiplier.

5. The gaming system of claim 1, wherein in response to a predetermined array element of the playfield becoming an additional symbol-bearing array element, the award amount includes a progressive-jackpot award.

6. The gaming system of claim 1, wherein in response to the predetermined combination achieving or exceeding a predetermined size or shape, direct the electronic display device to display a feature of the casino wagering game corresponding to the predetermined combination.

7. The gaming system of claim 1, wherein after the additional symbols no longer extend the predetermined combination, direct the electronic display device to display an outcome dialog box positioned relative to the predetermined combination.

8. The gaming system of claim 1, wherein each additional symbol-bearing array element of the final playfield outcome is directly adjacent to one or more symbols of the predetermined combination prior to display of the respective additional symbol.

9. The gaming system of claim 1, wherein the award amount is determined by at least one of a sum of individual values for the symbols of the predetermined combination, a sum of individual values associated with the location in the playfield of the array elements of the predetermined combination, a number of symbols in the predetermined combination, a sequence of symbols in the predetermined combination, a configuration of symbols of the predetermined combination, an amount of extension of the predetermined combination, or the predetermined combination including one or more specific array element locations of the playfield.

10. A gaming system, comprising:
a regulated gaming machine primarily dedicated to playing at least one casino wagering game, the gaming machine including an electronic display device and one or more electronic input devices; and
game-logic circuitry configured to:
detect, via at least one of the one or more electronic input devices, a physical item associated with a monetary value that establishes a credit balance and initiate a casino wagering game in response to an input indicative of a wager covered by the credit balance;
in response to initiating the casino wagering game, direct the electronic display device to display at least a portion of a playfield for providing symbol-bearing array elements;
direct the electronic display device to display randomly selected initial symbols in respective initial array elements of the playfield;
in response to a predetermined combination of the initial symbols, direct the electronic display device to iteratively display randomly selected additional symbols in additional symbol-bearing array elements adjacent to the predetermined combination, and present the randomly selected additional symbols in the respective additional symbol-bearing array elements of the playfield until the additional symbols no longer extend the predetermined combination, wherein at least one instance of the iterative displaying of additional symbol-bearing array elements occurs after at least one of the randomly selected additional symbols has been presented and at least one of the additional symbol-bearing array elements is separate from the initial array elements;
increment the credit balance with an award amount corresponding to an evaluation of the final playfield outcome; and
receive, via at least one of the one or more electronic input devices, a cashout input that initiates a payout from the credit balance.

11. The gaming system of claim 10, wherein in response to a predetermined symbol presented in an additional array element, a casino wagering game feature is triggered corresponding to the predetermined symbol.

12. The gaming system of claim 10, wherein in response to a predetermined additional array element of the playfield becoming an additional array element, a casino wagering game feature is triggered corresponding to the predetermined additional array element.

13. The gaming system of claim 12, wherein the casino wagering game feature is triggered in response to the predetermined combination achieving a predetermined shape or predetermined number of symbols.

14. The gaming system of claim 10, wherein an evaluation based upon the symbols of the predetermined combination, the location of the array elements of the predetermined combination, or a combination of both are used to determine the evaluation of the final playfield outcome.

15. A gaming system, comprising:
a regulated gaming machine primarily dedicated to playing at least one casino wagering game, the gaming machine including one or more electronic display devices and one or more electronic input devices;
game-logic circuitry configured to detect, via at least one of the one or more electronic input devices, a physical item associated with a monetary value that establishes a credit balance and initiate a casino wagering game in response to an input indicative of a wager covered by the credit balance, direct the electronic display device to display a playfield for providing symbol-bearing array elements upon initiating the casino wagering game, increment the credit balance with an award amount corresponding to an outcome of the casino wagering game, and receive, via at least one of the one or more electronic input devices, a cashout input that initiates a payout from the credit balance; and
means for directing the electronic display device to iteratively display additional symbol-bearing array elements separate from the initial array elements, and present randomly selected additional symbols in the respective additional symbol-bearing array elements of the playfield until the additional symbols no longer extend the predetermined combination, wherein at least one instance of the iterative displaying of additional symbol-bearing array elements occurs after at least one of the randomly selected additional symbols has been presented.

16. The gaming system of claim 15, further comprising means for determining whether an additional array element is a predetermined feature-triggering array element of the playfield, and if so, directing the electronic display device to display a feature of the casino wagering game corresponding to the predetermined feature-triggering array element.

17. The gaming system of claim 15, further comprising means for determining whether an additional symbol presents a predetermined feature-triggering symbol or the predetermined combination presents a predetermined feature-triggering combination, and if so, directing the electronic display device to display a feature of the casino wagering game corresponding to the predetermined feature-triggering symbol or the predetermined feature-triggering combination.

18. The gaming system of claim 15, further comprising means for directing the electronic display device to display an outcome dialog box positioned relative to the predetermined combination after the additional symbols no longer extend the predetermined combination.

19. The gaming system of claim 15, further comprising means for evaluating the outcome of the wagering game based upon the symbols of the predetermined combination, the location of the array elements of the predetermined combination, or a combination of both.

20. The gaming system of claim 18, further comprising means for evaluating the outcome of the wagering game based upon an additional symbol-bearing array element having an associated award multiplier, and increasing the award amount in accordance with the award multiplier.
